(19) United States
(12) Patent Application Publication
(10) Pub. No.: US 2018/0049852 A1
(43) Pub. Date: Feb. 22, 2018

(54) FLOSSING INSTRUMENT

(71) Applicants: Carlo Honanian, Glendale, CA (US); Jack Krikorian, West Hills, CA (US)

(72) Inventors: Carlo Honanian, Glendale, CA (US); Jack Krikorian, West Hills, CA (US)

(21) Appl. No.: 15/608,809

(22) Filed: May 30, 2017

Related U.S. Application Data
(63) Continuation-in-part of application No. 14/688,284, filed on Apr. 16, 2015, now abandoned.

(51) Int. Cl. A61C 15/04

(52) U.S. Cl. CPC A61C 15/046

(57) ABSTRACT

A multi-filament flossing instrument which supports more than one flossing filament thereon. The instrument comprises a handle and support frames on which the flossing filaments may be held taut, the support frames fixed to the handle. Filaments may be of different diameters. The instrument may have support frames on each end of the handle, and more than one support frame on each end of the handle. Any support frame may support more than one filament.

### CROSS-REFERENCE TO RELATED APPLICATION

This application is a Continuation-in-Part of application Ser. No. 14/688,284 filed Apr. 16, 2015 the contents of which are incorporated herein by this reference.

### FIELD OF THE DISCLOSURE

The present disclosure relates to flossing instruments, and more particularly, to an instrument which supports more than one flossing filament.

### BACKGROUND

Flossing is an effective way of promoting dental health. Some people support a flossing filament in their fingers while flossing. For convenience, flossing instruments having a handle and a frame on which is supported a single flossing filament have been provided. However, tooth contours and tooth spacing vary, even within a single mouth. Gaps between teeth may vary such that no one thickness or diameter of flossing filament meets all needs. A flossing instrument may provide a compact way of holding a flossing filament taut deep within the mouth, where free or open space is minimal. However, the angle of the flossing filament to the handle of the flossing instrument may not be conducive to effective flossing. There exists room in the art for improved flossing instruments.

### SUMMARY

The disclosed concepts address the above stated situation by providing flossing instruments offering greater versatility than known types. To this end, there is disclosed a flossing instrument supporting more than one flossing filament. The flossing instrument may support two, three, or even more flossing filaments. The tool comprises a plurality of arms joined to one another. The arms may be joined at a common point, or alternatively, may join a common post. Each arm may support one or more ends of one or more flossing filaments. Flossing filaments may vary in length and in diameter from one another. The arms may have a dedicated handle, or alternatively, for compactness, may be without a handle.

It is an object to provide improved elements and arrangements thereof by apparatus for the purposes described which is inexpensive, dependable, and fully effective in accomplishing its intended purposes.

These and other objects will become readily apparent upon further review of the following specification and drawings.

### BRIEF DESCRIPTION OF THE DRAWINGS

Various objects, features, and attendant advantages of the disclosed concepts will become more fully appreciated as the same becomes better understood when considered in conjunction with the accompanying drawings, in which like reference characters designate the same or similar parts throughout the several views, and wherein:

FIG. 1 is a perspective view of a multi-filament flossing instrument, according to at least one aspect of the disclosure;

FIG. 1A is a plan view of a multi-filament flossing instrument, according to at least one aspect of the disclosure;

FIG. 2 is a perspective view of a multi-filament flossing instrument, according to at least one further aspect of the disclosure;

FIG. 2A is a plan view of a multi-filament flossing instrument, according to an additional aspect of the disclosure;

FIG. 3 is a perspective view of a multi-filament flossing instrument, according to still at least one additional aspect of the disclosure;

FIG. 4 is a perspective view of a multi-filament flossing instrument, according to another aspect of the disclosure;

FIG. 5 is a perspective view of a multi-filament flossing instrument, according to still another aspect of the disclosure;

FIG. 6 is a perspective view of a multi-filament flossing instrument, according to a further aspect of the disclosure;

FIG. 7 is a perspective detail view of an alternative construction of the upper right of FIG. 6, according to still another aspect of the disclosure;

FIG. 8 is an end detail view of a multi-filament flossing instrument, according to yet another aspect of the disclosure;

FIG. 9 is an end detail view of a multi-filament flossing instrument, according to a further aspect of the invention; and

FIG. 10 is an end detail view of a multi-filament flossing instrument, according to yet another aspect of the invention.

### DETAILED DESCRIPTION

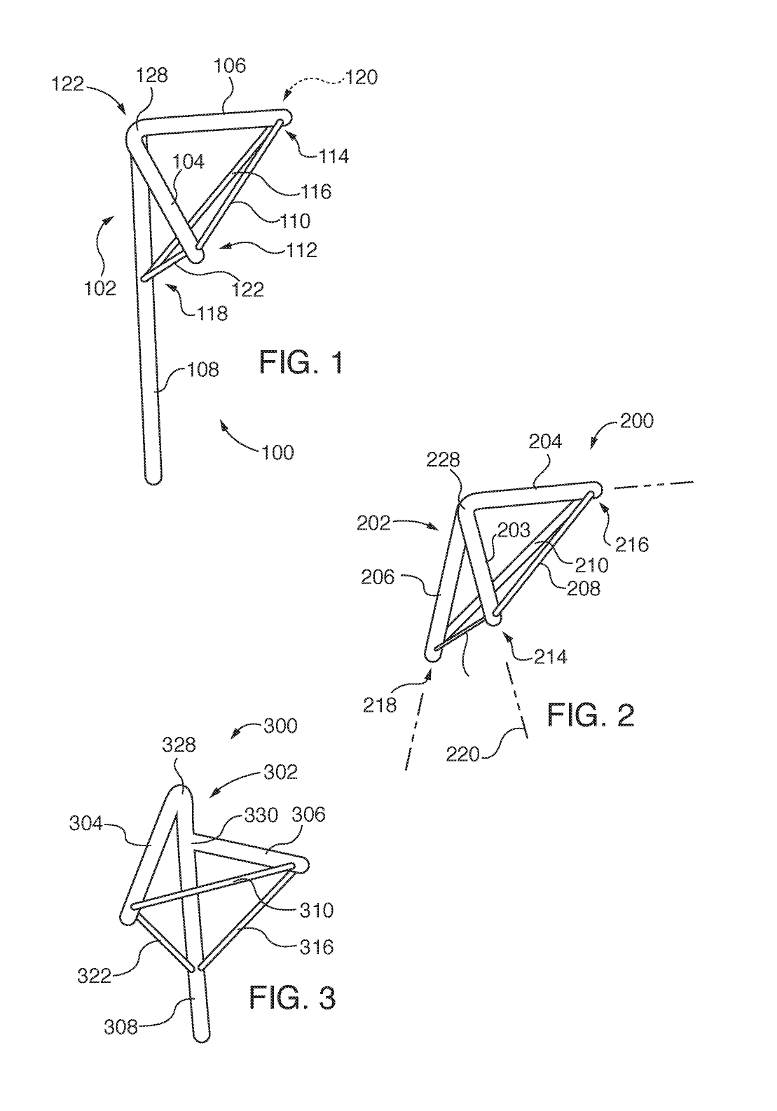

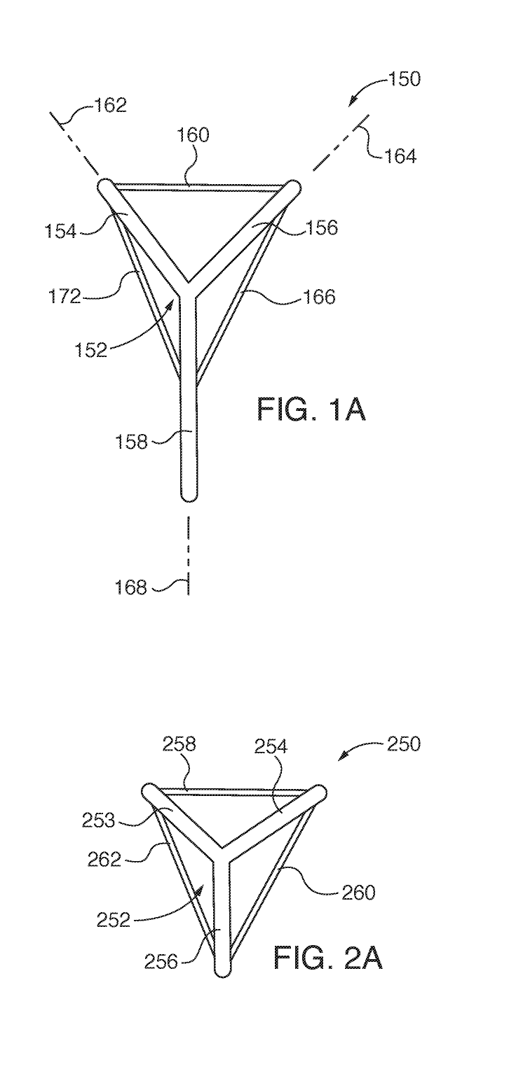

Referring first to FIG. 1, according to at least one aspect of the disclosure, there is shown a multi-filament flossing instrument 100, comprising a support frame 102 including a first arm 104, a second arm 106, and a third arm 108. A first filament 110 is fixed at one end 112 to first arm 104 and at an opposed end 114 to second arm 106. A second filament 116 is fixed at one end 118 to one of first, second, and third arms 104, 106, 108, and at an opposed end 120 to another one of first, second, and third arms 104, 106, 108. A third filament 122 is fixed at one end 124 to one of first, second, and third arms 104, 106, 108, and at an opposed end 126 to another one of first, second, and third arms 104, 106, 108. Support frame 102 will be understood to comprise arms 104, 106 and 108.

Provision of three filaments 110, 116, 122 gives the user a choice of filaments 110, 116, or 122. For any given surface portion of any given tooth being flossed, because filaments 110, 116 are differently oriented on support frame 102, one of filaments 110, 116, 122 may be more effective in reaching and scraping that surface portion. Filaments 110, 116, 122 may be embedded within first, second, and third arms 104, 106, 108, may be fusion bonded thereto, may be held by entrapment or interference, or may retained in any other suitable way.

Each filament 110, 116, or 122 is oriented so as to present at least a slightly different orientation to any one given tooth, compared to any other filament of any one multi-filament flossing instrument of the claims. This holds true for all implementations of all multi-filament flossing instruments disclosed herein.

Filaments 110, 116, 122 are of equal or identical diameters, and may be provided as three separate filaments, two separate filaments, or one continuous filament.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” or higher-numbered item.

Throughout this specification, and applying to all described and claimed implementations of the disclosure, because the disclosed multi-filament flossing instruments (e.g., multi-filament flossing instrument 100) are for flossing, filaments (e.g., filaments 110, 116) will be understood to comprise constituent material suitable for flossing. Also, because of the intended use as a flossing instrument, all multi-filament flossing instruments described or shown herein are dimensioned and configured to fit inside a human mouth. For example, In FIG. 1, in every one of the disclosed multi-filament flossing instruments described or shown herein, first and second arms 104, 106 are no greater in length than three quarters of an inch.

Furthermore, in all implementations of this disclosure, the term “support frame” (e.g., support frame 102 in FIG. 1) will refer to those arms shown and described for each implementation (e.g., arms 104, 106, 108 in FIG. 1).

In the example of FIG. 1, first, second, and third arms 104, 106, 108 join to one another at a common point 128 on support frame 102. Common point 128 is the intersection of first, second, and third arms 104, 106, 108.

At least two of first, second, and third arms 104, 106, 108 are of different lengths. As illustrated, third arm 108 is longer than first and second arms 104, 106. Arm 108 is sufficiently long to serve as a handle for finger grasp and manipulation of multi-filament flossing instrument 100.

FIG. 1A shows a multi-filament flossing instrument 150 which is generally similar to multi-filament flossing instrument 100, except that first, second, and third arms 154, 156, 158 of frame 152, and first, second, and third filaments 160, 166, 172 are all generally coplanar. That is, longitudinal centerlines 162, 164, 168 of first, second, and third arms 154, 156, 158 are coplanar.

Referring now to FIG. 2, a multi-filament flossing instrument 200 has first, second, and third arms 203, 204, 206 of equal length. First, second and third filaments 208, 210, 212 are each fixed at opposed ends to two of free ends 214, 216, 218 of first, second, and third arms 203, 204, 206. In the example of FIG. 2, first, second, and third arms 203, 204, 206 join to one another at a common point 228 on support frame 202. 10. In multi-filament flossing instrument 200, the first and second filaments 208, 210 are of equal length. However, in multi-filament flossing instrument 200, the first and second filaments 208, 210 are of different diameters. Third filament 212 may be of still another diameter if desired, or may be the same as one of first and second filaments 208, 210.

FIG. 2A shows a multi-filament flossing instrument 250 which corresponds to multi-filament flossing instrument 150, except that in the former, first, second, and third arms 253, 254, 256 are of equal length. First, second, and third arms 253, 254, 256 of frame 252 are coplanar, as are first, second, and third filaments 258, 260, 262.

Turning now to FIG. 3, a multi-filament flossing instrument 300 includes a frame 302 comprising first, second, and third arms 304, 306, and 308. First, second, and third filaments 310, 316, 322 are fixed to first, second, and third arms 304, 306, 308. The first and second arms 304, 306 join to the third arm 308 at points 328, 330 spaced apart from one another along the third arm 308.

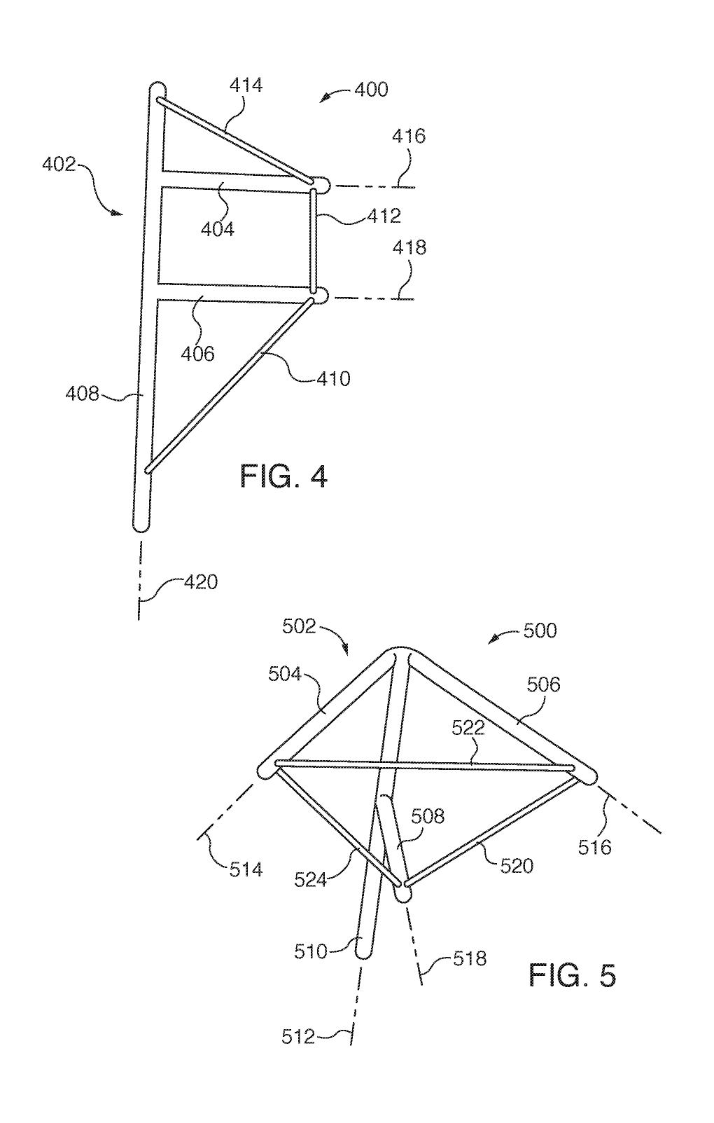

As seen in FIG. 4, a multi-filament flossing instrument 400 includes first, second, and third arms 404, 406, 408 joined together to form a frame 402. First, second, and third arms 404, 406, 408 support first, second, and third filaments 410, 412, 414 in a manner similar to that of multi-filament flossing instruments 100, 200, and 300 of FIGS. 1, 2, and 3. Longitudinal center lines 416, 418, 420 of respective first, second, and third arms 404, 406, 408 are coplanar. By contrast with multi-filament flossing instrument 400, center lines of the first, second, and third arms are distributed throughout three dimensions. For example, in FIG. 2, center lines 220, 222, and 224 of first, second, and third arms 203, 204, and 206 are distributed throughout, or occupy, three dimensions.

Turning now to FIG. 5, a multi-filament flossing instrument 500 comprises a frame 502 including a first arm 504, a second arm 506, and third arm 508, and a fourth arm 510. Center line 512 of the fourth arm 510 is not aligned with the center lines 514, 516, 518 of any of the first, second, and third arms 504, 506, 508. First, second, and third filaments 520, 522, 524 are fixed to first, second, and third arms 504, 506, 508. The first and second filaments 520, 522 are of different lengths.

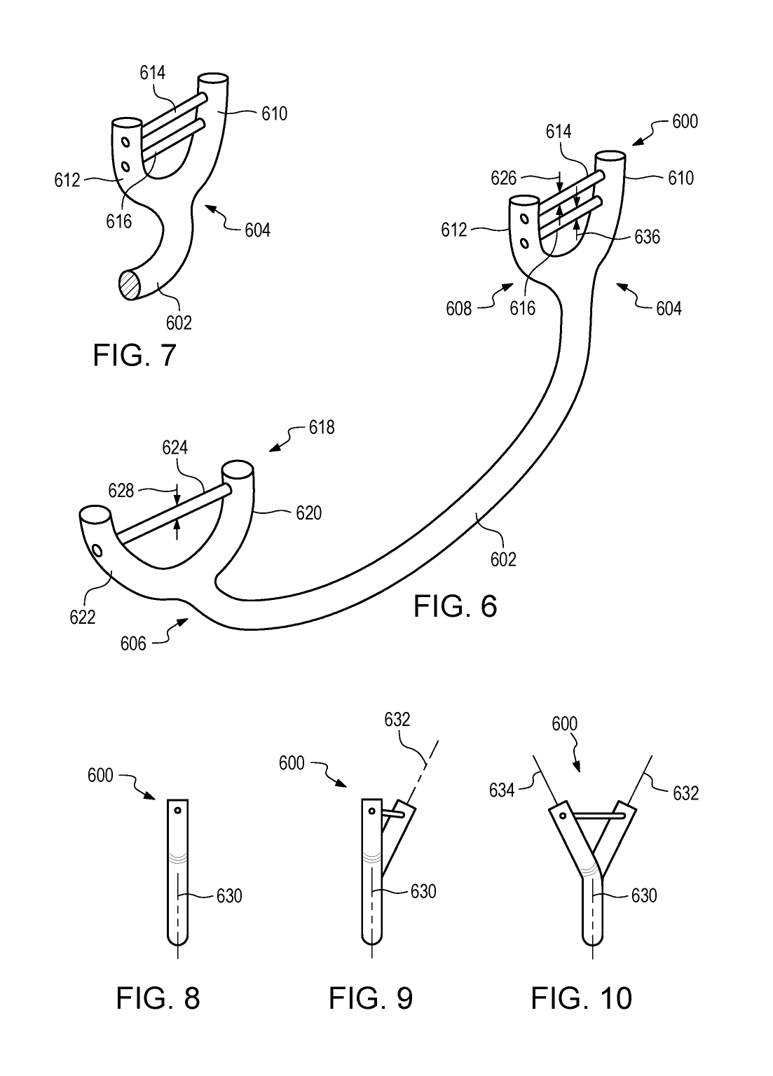

Turning now to FIG. 6, there is shown a multi-filament flossing instrument 600, comprising an elongated handle 602 having a proximal end 604 and a distal end 606, a first support frame 608 fixed to proximal end 604 of elongated handle 602. First support frame 608 includes at least a first arm 610 projecting from first support frame 608 proximate proximal end 604 of elongated handle 602, and at least a second arm 612 projecting from elongated handle 602 proximate first arm 610, a first filament 614 fixed at one end to first arm 610 and at an opposed end to second arm 612, and a second filament 616 fixed at one end to first arm 610 and at an opposed end to another arm (e.g., second arm 612, although in other embodiments such as those of FIGS. 1-5, to a third arm). As employed herein, a support frame refers to any pair arms (e.g., arms 610 and 612) spaced apart from one another and capable of holding one or more filaments taut between them.

In FIGS. 6-10, extensions of filaments (e.g., first and second filaments 614, 616) are depicted as small circles. This is intended as a visual aid enabling an observer to better picture orientation of the filament relative to its respective support frame. It should not be inferred that filaments actually fully penetrate their associated arms (e.g., arms 610, 612).

In the example of FIG. 6, first filament 614 and second filament 616 are each fixed at one end to first arm 610 and at an opposed end to second arm 612. In FIG. 6, first filament 614 and second filament 616 are not equidistant from elongated handle 602. Alternatively stated, one is above the other as viewed in FIG. 6. This increases the number of passes of a filament against a particular tooth (not shown) in one stroke of multi-filament flossing instrument 100 when flossing. However, this is not the only possible configuration. Referring to FIG. 7, first filament 614 and second filament 616 are equidistant from elongated handle 602. This enables one of filaments 614 and 616 to bear against a tooth without obliging first and second arms 610, 612 to be pressed against or interfere with teeth. Although only one arm 610 or 612 could be provided, providing both promotes ready contact with teeth from either of two opposed sides of the tooth, or alternatively, facilitates right and left handed usage of multi-filament flossing instrument 100.

In addition, provision of more than one filament on any one support frame assures that if one filament breaks, multi-filament flossing instrument 100 will still be immediately usable.

Again referring specifically to FIG. 6, multi-filament flossing instrument 100 may further comprise a second support frame 618 fixed to distal end 606 of elongated handle 602. Second support frame 618 may include at least a third arm 620 projecting from second support frame 618 proximate distal end 606 of elongated handle 602, at least a fourth arm 622 projecting from elongated handle 602 proximate third arm 620, and at least a third filament 624 fixed at one end to third arm 620 and at an opposed end to fourth arm 622. At least one of first filament 614 and second filament 616 has a first diameter 626, and third filament 624 has a second diameter 628 different from first diameter 626. Providing filaments of different diameters may promote more effective flossing by for example, varying conformity of the filament to any given tooth at a particular level of manual pressure imposed on multi-filament flossing instrument 100. Illustratively, a smaller diameter filament may conform better to a tooth, thereby wrapping around more of the circumference of that tooth and effectively scraping more tooth area for each stroke of multi-filament flossing instrument 100. Conversely, a relatively thick filament may avoid hanging up in crevices or other irregularities of the surface of the tooth. Also, smaller diameter filaments may better penetrate more tightly spaced teeth. Larger diameter filaments may be more resistant to breakage.

Referring now to FIG. 8, which shows multi-filament flossing instrument 100 in end view, first arm 610, second arm 612, third arm 620, fourth arm 622, and handle 602 may all be coplanar, occupying plane 630. Seen in the end view of FIG. 8, plane 630 is a line. This enables a user to intuitively grasp orientation of multi-filament flossing instrument 100 relative to the teeth after switching which support frame 608 or 618 contacts the teeth.

FIGS. 9 and 10 illustrate other possible variations. In FIGS. 9 and 10, first arm 610 and second arm 612 are coplanar, and third arm 620 and fourth arm 622 are offset from plane 632 occupied by first arm 610 and second arm 612. Third and fourth arms 620, 622 occupy 630.

In FIGS. 6 and 8, first arm 610 and second arm 612 are coplanar with elongated handle 602, occupying plane 630.

In FIGS. 9 and 10, first arm 610 and second arm 612 are not coplanar with elongated handle 602. First and second arms 610, 612 occupy 632 in each of FIGS. 9 and 10.

Specifically in FIG. 10, first arm 610 and second arm 612 are not coplanar with elongated handle 602, and third arm 620 and fourth arm 622 are not coplanar with either elongated handle 602 or with first arm 610 and second arm 612. Third and fourth arms 620, 622 occupy a plane 634 in FIG. 10.

The variations of FIGS. 9 and 10 offer slight difference and provide slight versatility in maneuvering multi-filament flossing instrument 100, which may be preferable to different users when accounting for variations in human physiology of the mouth. According to a further aspect of the disclosure, and referring primarily to FIG. 6, multi-filament flossing instrument 100 may comprise elongated handle 602 having proximal end 604 and distal end 606, and first support frame 608 fixed to proximal end 604 of elongated handle 602. First support frame 608 may include at least first arm 610 projecting from first support frame 608 proximate proximal end 604 of elongated handle 602, and at least second arm 612 projecting from elongated handle 602 proximate first arm 610, first filament 614 fixed at one end to first arm 610 and at an opposed end to second arm 612, and second filament 616 fixed at one end to first arm 610 and at an opposed end to another arm, such as arm 612. However, in other embodiments, such as those illustrated in FIGS. 1-5, second filament 616 may span first arm 610 and an arm other than arm 612. Alternatively stated, first and second filaments 614 and 616 may span support frames each having two arms dedicated to any one filament, or, as shown in FIGS. 1-5, filaments may span support frames sharing an arm between two abutting support frames.

As shown in FIG. 6, in multi-filament flossing instrument 100 described immediately above, at least one of first filament 614 and second filament 616 has first diameter 626, and third filament 624 has a second diameter 628 different from first diameter 626.

Filaments on the same support frame may have different diameters. Still referring to FIG. 6, first filament 614 may have first diameter 626, and second filament 612 may have a third diameter 636 different from first diameter 626.

Placement of filaments of different diameters in different support frames and locations may increase versatility of multi-filament flossing instrument 100, or suitability of multi-filament flossing instrument 100 for different physiologies.

Continuing to refer to primarily to FIG. 6 but also to FIGS. 7-10, where multi-filament flossing instrument 100 may comprise elongated handle 602 having proximal end 604 and distal end 606, and first support frame 608 fixed to proximal end 604 of elongated handle 602, and where first support frame 608 may include at least first arm 610 projecting from first support frame 608 proximate proximal end 604 of elongated handle 602, and at least second arm 612 projecting from elongated handle 602 proximate first arm 610, first filament 614 fixed at one end to first arm 610 and at an opposed end to second arm 612, and second filament 616 fixed at one end to first arm 610 and at an opposed end to another arm, multi-filament flossing instrument 100 may comprise second support frame 618 fixed to distal end 606 of elongated handle 602. Second support frame 618 may include at least third arm 620 projecting from second support frame 618 proximate proximal end 604 of elongated handle 602, and fourth arm 622 projecting from second support frame 618 proximate third arm 620.

Alternatively stated, multi-filament flossing instrument 100 may comprise first and second filaments fixed to diverse arms (e.g., first arm 610, for supporting a filament), the filaments may be fixed to separate support frames each having arms dedicated to one filament, or alternatively, the filaments may be fixed to support arms having shared arms receiving and supporting filaments fixed at their other ends to arms of two different support frames. In an example of the alternate described immediately above, multi-filament flossing instrument 100 may further comprise a further filament 624 fixed at one end to third arm 620 and at an opposed end to fourth arm 622 (FIG. 6), or in alternative embodiments, may comprise filaments 520 or 522 utilizing arms spanning different support frames (e.g., in the arrangement shown in FIG. 5).

Flossing filaments may be taut as illustrated, or alternatively, may be somewhat longer than the distance separating their respective attachment points to arms. The latter option allows for a flossing filament to partially wrap around a tooth when being used to floss teeth.

As shown herein, arms are straight. However, arms could take other configurations, such as curved and bent.

While the disclosed concepts have been described in connection with what is considered the most practical and preferred implementation, it is to be understood that the disclosed concepts are not to be limited to the disclosed arrangements, but are intended to cover various arrangements which are included within the spirit and scope of the broadest possible interpretation of the appended claims so as to encompass all modifications and equivalent arrangements which are possible.

It should be understood that the various examples of the apparatus(es) disclosed herein may include any of the components, features, and functionalities of any of the other examples of the apparatus(es) disclosed herein in any feasible combination, and all of such possibilities are intended to be within the spirit and scope of the present disclosure. Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A multi-filament flossing instrument, comprising:
an elongated handle having a proximal end and a distal end; and
a first support frame fixed to the proximal end of the elongated handle, the first support frame including at least a first arm projecting from the first support frame proximate the proximal end of the elongated handle and at least a second arm projecting from the elongated handle proximate the first arm, wherein the first support frame includes
a first filament fixed at one end to the first arm and at an opposed end to the second arm, and
a second filament fixed at one end to the first arm and at an opposed end to the second arm.

2. The multi-filament flossing instrument of claim 1, further comprising a second support frame fixed to the distal end of the elongated handle, the second support frame including at least a third arm projecting from the second support frame proximate the distal end of the elongated handle and at least a fourth arm projecting from the elongated handle proximate the third arm, and at least a third filament fixed at one end to the third arm and at an opposed end to the fourth arm.

3. The multi-filament flossing instrument of claim 2, wherein the first arm, the second arm, the third arm, and the fourth arm are all coplanar.

4. The multi-filament flossing instrument of claim 2, wherein the first arm and the second arm are coplanar, and the third arm and the fourth arm are offset from a plane occupied by the first arm and the second arm.

5. The multi-filament flossing instrument of claim 4, wherein the first arm and the second arm are coplanar with the elongated handle.

6. The multi-filament flossing instrument of claim 4, wherein the first arm and the second arm are not coplanar with the elongated handle.

7. The multi-filament flossing instrument of claim 4, wherein the first arm and the second arm are not coplanar with the elongated handle, and the third arm and the fourth arm are not coplanar with neither the elongated handle nor with the first arm and the second arm.

8. The multi-flossing instrument of claim 2, wherein at least one of the first filament and the second filament has a first diameter, and the third filament has a second diameter different from the first diameter.

9. The multi-flossing instrument of claim 1, wherein the first filament and the second filament are not equidistant from the elongated handle.

10. The multi-flossing instrument of claim 1, wherein the first filament and the second filament are equidistant from the elongated handle.

11. A multi-filament flossing instrument, comprising:
an elongated handle having a proximal end and a distal end;
a first support frame fixed to the elongated handle, the first support frame including at least a first arm projecting from the first support frame proximate the proximal end of the elongated handle and at least a second arm projecting from the elongated handle proximate the first arm, and a first filament fixed at one end to the first arm and at an opposed end to the second arm; and
a second support frame fixed to the elongated handle, the second support frame including at least a third arm projecting from the second support frame proximate the distal end of the elongated handle and a fourth arm projecting from the second support frame proximate the distal end of the elongated handle, and a second filament fixed at one end to the third arm and at an opposed end to the fourth arm, wherein
the first filament has a first diameter and the second filament has second diameter different from the first diameter.

12. The multi-filament flossing instrument of claim 11, wherein the first support frame is fixed to the elongated handle at the proximal end, and the second support frame is fixed to the elongated handle at the distal end.

13. The multi-filament flossing instrument of claim 11, wherein the first support frame and the second support frame are each fixed to the elongated handle at the proximal end.
